(19) United States
(12) Patent Application Publication
(10) Pub. No.: US 2003/0116023 A1
(43) Pub. Date: Jun. 26, 2003

(54) Method of anti-pollution for exhaust and apparatus thereof

(76) Inventor: Bor-Jye Liang, Shichih City (TW)

Correspondence Address: BRUCE H. TROXELL, SUITE 1404, 5205 LEESBURG PIKE, FALLS CHURCH, VA, 22041, US

(21) Appl. No.: 10/086,881

(22) Filed: Mar. 4, 2002

(30) Foreign Application Priority Data
Dec. 24, 2001 (TW) 090131994

(51) Int. Cl. B01D 46/00

(52) U.S. Cl. 96/380; 55/512; 95/274

(57) ABSTRACT

A method of anti-pollution for exhaust and a device thereof provide a closed housing filled with filter materials and clearances between the filter materials. A discharge part of the exhaust is connected to an inlet hole disposed at an end of the housing and an outlet hole is disposed at another end of the housing for guiding the treated exhaust out. The exhaust is guided into the housing and a plurality of contaminating particles in the exhaust are left in the housing and the pollution resulting from the treated exhaust can be reduced greatly before being guided out from the housing.

### BACKGROUND OF THE INVENTION

1. Field of The Invention

The present invention relates to a method of anti-pollution for exhaust and apparatus thereof. In particular, the present invention relates to a method for eliminating or separating suspended particles in the exhaust and an apparatus to perform the method.

2. Description of Related Art

The exhaust, especially the exhaust after combustion, being discharged to the open air often is a struggled issue with regard to the environment protection. The exhaust produced by the burned fuel basically is aggregation of micro particles regardless the fuel is oil fuel or coal. If the micro particles are discharged in the atmosphere, it is natural that the environment becomes polluted. Hence, to solve the problem caused by the contamination source of the discharged exhaust is a subject we always care about. Especially, the exhaust generated from the diesel oil or the heavy oil is extremely shocked at the sight of us.

In order to solve the problem of exhaust contamination, the supplier of the technique dealing with environment protection have developed various anti-pollution methods or apparatuses associated with different techniques. However, although each technique has its advantages, it still exists disadvantages also. A brief summary for their advantages and disadvantages are listed hereinafter:

1. The electrostatic precipitator (E/P) type dust collector is used for collecting suspended micro particles and it offers good effect but it is too expensive and the size thereof is too huge.

2. The bag filter type dust collector can filter micro suspended particles but it is unable to endure the high temperature so that it is impossible to treat the glutinous matter. Further, the filter net is expensive so that the anti-pollution cost has be higher.

3. The cyclone type dust collector is lower in price but the treatment efficiency is not high. Especially, it is not possible for the cyclone type dust collector to collect the suspended particles with smaller sizes.

4. The water spray (wash) type dust collector provides a lower cost but the wastewater may result in a problem of second pollution.

5. The cordierite ceramic filter core offers an excellent filtering effect but it is only possible to treat a small amount of exhaust. Further, the ceramics is fragile and expensive.

### SUMMARY OF THE INVENTION

The crux of the present invention resides in the fact that a method of anti-pollution for exhaust and a apparatus thereof, which provides a closed housing filled with filter materials and clearances between the filter materials for being passed through the exhaust and the suspended particles in the exhaust can be filtered out. A discharge part of the exhaust is connected to an inlet hole disposed at an end of the housing and an outlet hole is disposed at another end of the housing for guiding the treated exhaust out. The exhaust is guided into the housing and a plurality of contaminating particles in the exhaust are left in the housing and the pollution resulting from the treated exhaust can be reduced greatly before being guided out from the housing.

### BRIEF DESCRIPTION OF THE DRAWINGS

The present invention can be more fully understood by reference to the following description and accompanying drawings, in which:

FIG. 1 is a perspective view of a single dust collection box according to the present invention;

FIG. 2 is a sectional view of collection box of the present invention illustrating shields being added; and

FIG. 3 is an exploded perspective view of box net type dust collection according to the present invention.

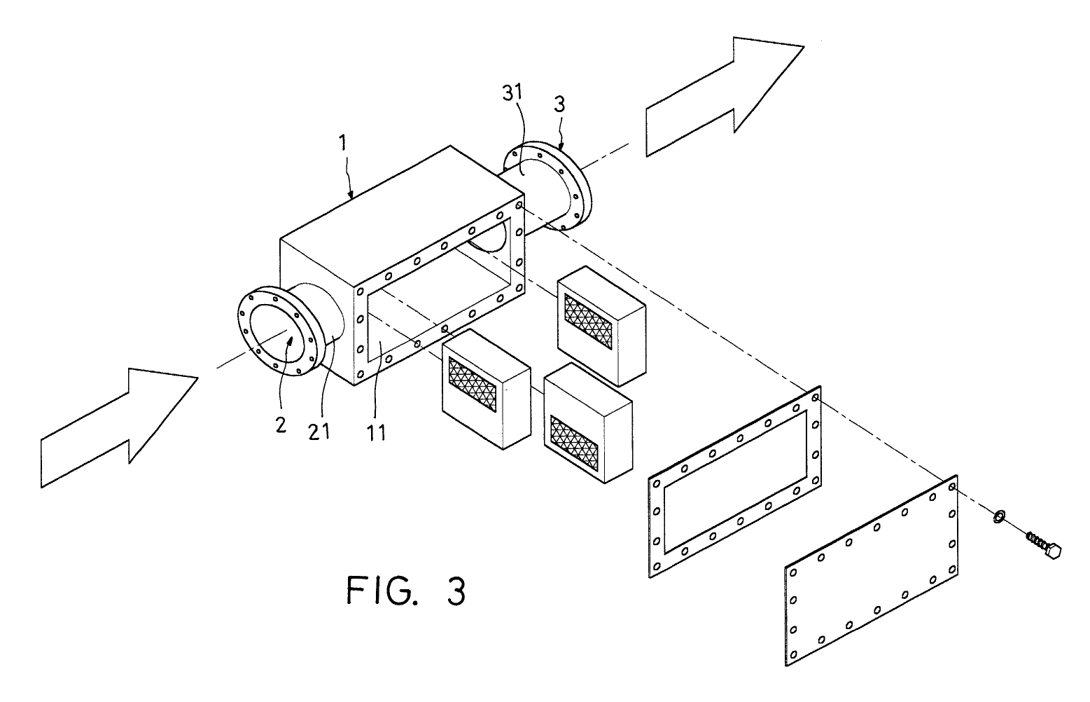

### DETAILED DESCRIPTION OF THE PREFERRED EMBODIMENTS

Basically, a principle of the present invention resides in that dust collection material is utilized to hinder and/or to adsorb particles in the exhaust such that the fine particles can stagnate due to collision, viscosity, or static electricity and can be adsorbed by the collection material or fall down due to the gravity. Hence, the contamination of the exhaust can be removed and the polluted particles can be separated and collected for further treatment.

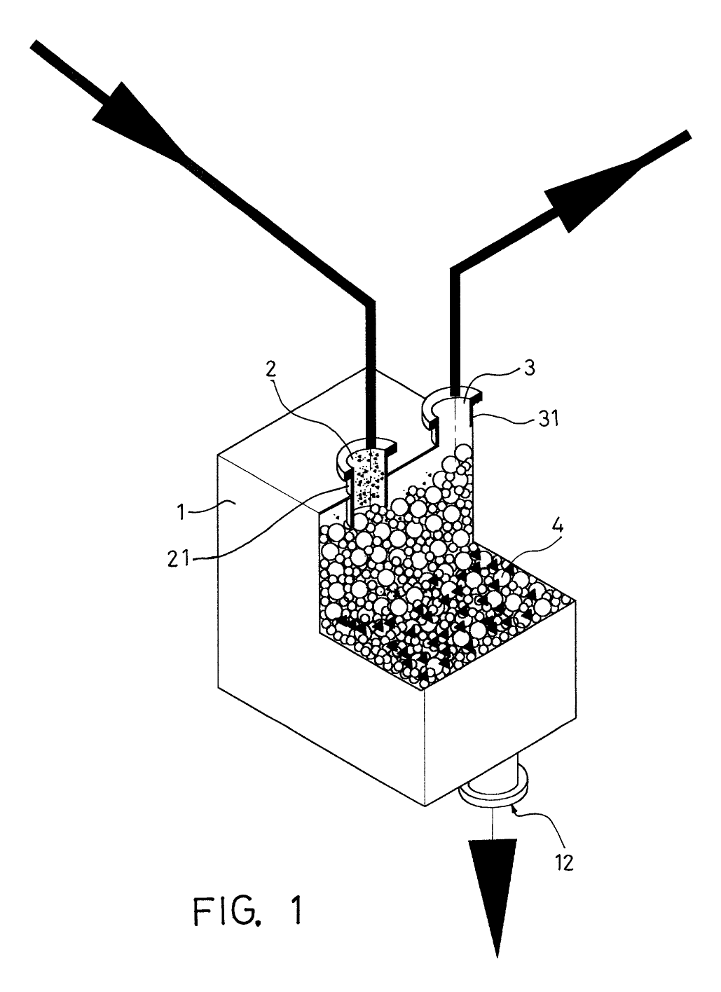

Referring to FIG. 1, an anti-polluted apparatus for exhaust according to the present invention comprises a housing 1, an inlet hole 2, an outlet hole 3 and filter material 4.

Wherein, the housing 1 has a closed shape with an inner filtering chamber 11 for receiving filter material, and the inlet hole 2 and the outlet hole 3 are disposed at the wall of the housing. The housing 1 can be provided with a shape of cylinder, rectangular parallelepiped and etc. and at the bottom thereof may provide an infundibuliform dust collection hole 12 for discharging polluted particles.

The inlet hole 2 is disposed at the housing 1 to communicate with the interior of the housing 1 and the purpose of the inlet hole 2 is for connecting with the discharge pipe of the exhaust so that an inlet pipe 21 can be extended from the inlet hole 2 to join the discharge pipe.

The outlet hole 3 is disposed at the housing 1 to communicate with the housing 1 and the purpose of the outlet hole 3 is for discharging the filtered exhaust so that an outlet pipe 31 can be extended from the outlet hole 3 for guiding the treated exhaust out.

The filter material 4 is used for colliding with and/or adsorbing the particles in the exhaust so that it can be an aggregation of a plurality of particle shaped filtering elements, be composed of multi-layer filtering grids, or be a combination of particle filtering elements and the filtering grids. In case of the filter material being an aggregation of particle shaped filtering elements, the particle shaped filtering elements are packed with clearances between particle filtering elements for being passed by the exhaust and the particle filtering elements can be made of fiber, stone, pottery, porcelain, ceramics, metal or resin. The filter material 4 can be aggregated with particle filtering elements with identical material or two or more different materials and each of the filtering element can provided with a shape of ball, cube, rectangular parallelepiped or any other irregular shape. In addition, a better effect can be obtained if the outer surface of each filtering element is treated with catalyst convert agent.

In practice, place anti-pollution bags, which are filled with the aggregated filter material, into the filtering chamber 11 in the housing 1 and the inlet hole 2 is connected to the exhaust discharge port before the exhaust can be filtered. Then, the exhaust is forced to enter the filtering chamber 11 by way of wind pressure and the contaminating particles accompanying the exhaust can stain onto the filter material 4 or slow down the velocity thereof due to collision. The contaminating particles may fall down to the bottom because of energy loss after multiple collisions and the fallen contaminating particles are discharged via the collection hole 12.

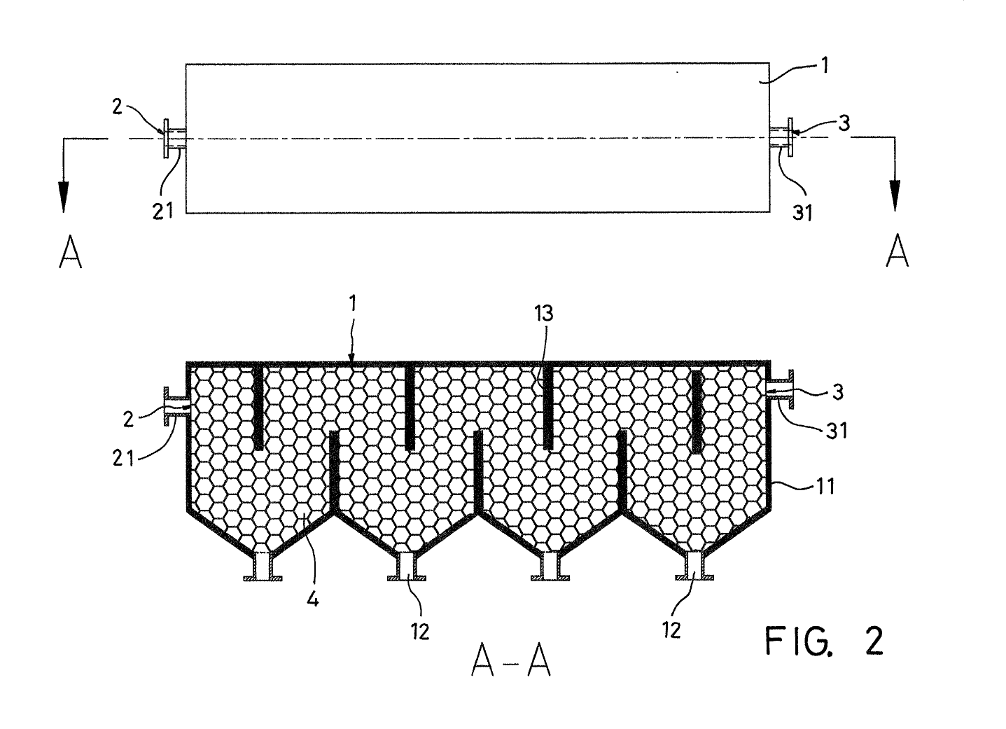

In order to prove the effectiveness of the present invention, an explanatory example as shown in FIG. 2 illustrates a windmill A connects with a 1″ exhaust pipe B with the blast volume 0.5 m3/min and a temperature of 27° C. and the flour serves as simulated suspension particles. A housing with a 120 mm (W)*120 mm (L)*180 mm (H) dust collection trough contains the filter material, which is a mixture of filtering elements with grain sizes in a range of 1 mm˜10 mm. As soon as the windmill is starts, 80 grams of flour are sprayed into the windpipe in front of the dust collection trough. Once the windmill is stopped, the flour collected at the bottom of the dust collection trough is 65 grams. It means that the dust collecting efficiency is 81%, that is, 80 percentages of the suspended micro particles can be removed.

Referring to FIG. 2 again, the filtering chamber 11 in the housing 1 is attached with one or more non-completely closed partitions 13 as shields to perform multiple filtrations such that contaminating particles in the exhaust can be removed effectively.

If the surface of the filter material 4 is provided with catalyst convert agent such as platinum, palladium, germanium or rare earth element, the effect for removing HC, CO, NO and PM (SOOT) can be enhanced greatly.

Because the housing is filled with the filter material 4, it is possible to occur problems such as excessive pressure and temperature rise. The relief valve and the temperature controller can be added to the housing to relieve the pressure and to lower the temperature in the housing 1. The technique related to the pressure relief and the temperature reduction is prior art so that no detail will be described further. Meanwhile, a conventional muffler and/or turbulent or ash blowing device may be added to the pollution prevented device of the present invention to eliminate the noise and to collect the contaminated particle within the turbulence.

It is appreciated from the preceding embodiment that the present invention can hinder and stagnate the contaminating particles in the exhaust by way of the filter material while the exhaust passes through the filtering chamber in the housing so that the exhaust discharged from the anti-pollution device of the present invention can reduce the pollution gradients thereof to the environment. Further, the filtering material can be replaced or cleaned at regular time to keep the anti-pollution device of the present invention in a good condition. The set up cost and the operation cost for the anti-pollution device of the present invention are low so that it is capable of being utilized in industries such as treating the exhaust of a car. These advantages of the invention are not possible for the conventional anti-pollution device can reach effectively.

While the invention has been described with reference to the preferred embodiment thereof, it is to be understood that modifications or variations may be easily made without departing from the spirit of this invention, which is defined by the appended claims.

What is claimed is:

1. A method of anti-pollution for exhaust, comprising the following steps:
(1) providing a closed housing filled with a plurality of filter materials and a plurality of clearances being between the filter materials;
(2) connecting a discharge part of the exhaust to a hole at an end of the closed housing and another hole at another end of the closed housing for leading treated exhaust out; and
(3) introducing the exhaust into the closed housing and a plurality of contaminating particles in the exhaust being left in the closed housing and the treated exhaust being capable of reducing original pollution thereof after being led out from the closed housing.

2. The method of anti-pollution for exhaust according to claim 1, wherein the housing can have a single space or can be separated into two or more communicating rooms with one or more partitions being added.

3. The method of anti-pollution for exhaust according claim 1, wherein an interior of the housing can be formed with a plurality of separated zones by way of intervening with a plurality of grids and each of the separated zones can be added with the filter materials.

4. The method of anti-pollution for exhaust according claim 1, wherein the filter materials are a plurality of filtering particles, which can be formed with different shapes, and the filtering particles can be made of one or more of metal, fiber, stone, pottery, porcelain, ceramics, resin and cotton.

5. The method of anti-pollution for exhaust according claim 1, wherein the housing can be added with a relief valve for reliving an excessive pressure and/or a temperature controller for a temperature reduction.

6. The method of anti-pollution for exhaust according claim 1, wherein the filter material on a surface thereof can be added with catalyst convert agent.

7. An anti-pollution device for exhaust, comprises
a housing, providing an inner filtering chamber;
an inlet hole, being provided on the housing to communicate the filtering chamber;
an outlet hole, being provided at the filtering chamber of the housing to communicate with a wall of the housing;
a plurality of filter materials, being congregated and filled in the housing with a plurality of clearances between the filter materials;
whereby, once the inlet hole connects with a discharge port for the exhaust, a plurality of contaminating particle in the exhaust can stay in the filtering chamber while the exhaust passes through the filtering chamber so that the exhaust may reduce the pollution to the environment.

8. The anti-pollution device for exhaust according to claim 7, wherein the inlet hole and the outlet hole can extend a distance of pipe section respectively.

9. The anti-pollution device for exhaust according to claim 7, wherein the housing can be added with a relief valve for reliving an excessive pressure and/or a temperature controller for a temperature reduction.

10. The anti-pollution device for exhaust according to claim 7, wherein a muffler can be added to the housing.

11. The anti-pollution device for exhaust according to claim 7, wherein an agitator and/or a ash blow device can be added into the housing.

12. The anti-pollution device for exhaust according to claim 7, wherein the filter materials are a plurality of filtering particles, which can be formed with different shapes, and the filtering particles can be made of one or more of metal, fiber, stone, pottery, porcelain, ceramics, resin and cotton.

13. The anti-pollution device for exhaust according to claim 7, wherein the filtering chamber can be formed with two or more rooms by way of a or more partitions with each of the rooms being filled with the filter materials and a passage communicates with the rooms.

14. The anti-pollution device for exhaust according to claim 13, wherein each of the partitions can be a box net with grids.
